(19) United States
(12) Patent Application Publication
(10) Pub. No.: US 2019/0355230 A1
(43) Pub. Date: Nov. 21, 2019

(54) Baby Gizmo

(71) Applicant: Yvonne Annie Miller, Sunrise, FL (US)

(72) Inventor: Yvonne Annie Miller, Sunrise, FL (US)

(21) Appl. No.: 16/441,973

(22) Filed: Jun. 14, 2019

(51) Int. Cl. G08B 21/22; B60N 2/00; B60N 2/28

(52) U.S. Cl. CPC G08B 21/22; B60N 2/28; B60N 2/002

(57) ABSTRACT

The BABYGIZMO is a device installed at the base of a car seat that contains a sensor linked to another device, such as a smart phone or wristband/bracelet, worn by a parent or individual who is taking a child out for a ride. The sensor will automatically trigger and send a signal to the individual's personal device when a child is placed in a car seat. If for any reason the child is left behind in the car seat and the parent/individual walks away from the car within 15 feet, their personal device will beep/vibrate to send an alert that the child is inside the vehicle. The device can connect to an app for smart phones and Bluetooth for any vehicle.

There are so many senseless accidents with parent(s) forgetting that they have a child in the vehicle with them and are being left the vehicle in smoldering heat.

My ideas will be developed to reminder the parent and/or individual that there is a child in the vehicle, THIS WILL SAFE LIVES AND GIVE THE PARENT(S)/GUARDIAN PEACE OF MIND!

This will be a device that's installed in the base of the car seat, for example, a sensor link to a wristband/bracelet that's worn by the parent/individual who will be taking this child out for a ride. This sensor will have a code number (unique to each car seat) that's program to a wristband/bracelet and will automatically trigger and send a signal to the bracelet/wristband as soon as that child is placed in the car seat. Upon reaching their destination, if for any reason the child is left in the car seat and the individual wearing the wristband/bracelet walked 15 feet from the vehicle the bracelet/wristband will vibrate and/or beep which will alert the individual that they forgot something in the vehicle. The device that's installed in the car seat should be cover by material that is durable, shock resistant and waterproof (e.g. material use to make a soft ball). The size of the sensor should be the size of a lollipop. The band for the wrist should be an open bracelet made from material that is used on watches (giving a stylish look). The sensor that's placed on top of the wristband/bracelet (Watch-like Face) should be designed to look like the face of a watch.

This device can also be installed as an APP for cell phones and also be able to connect to a Blue Tooth in any vehicle.

The sensor that's goes on the bracelet should also be placed in a shock resistance cover for protection.
The substitute specification includes no new matter.

### BRIEF DESCRIPTION OF THE DRAWINGS

FIG. 1: shows the Device

FIG. 2: Show where the Device will be placed in the wristband.

FIG. 3: Shows the Band use to secure this Device on the wrist.

FIG. 4: Shows where the Device is placed in the Car Seat.

FIG. 5: Shows the Baby Car Seat

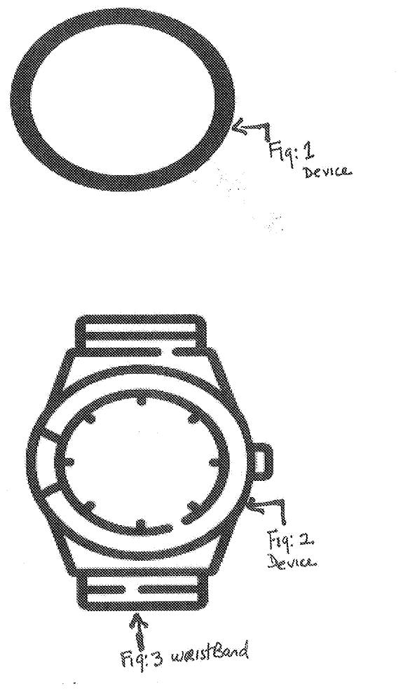

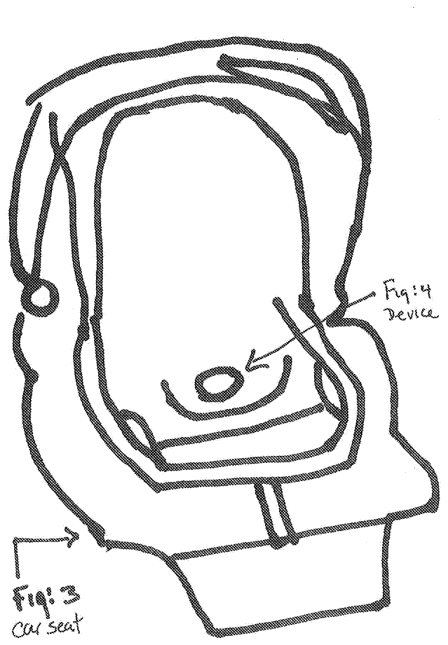

WHEN THE CHILD IS PLACED IN THE CAR SEAT THE WRISTBAND/BRACELET WILL LITE ONCE FOR 10 SECOND TO SHOW THAT THE DEVICE IS ACTIVATED.

I claim:

1. This electronic device is comprised of an electronic chip that's incased in a round mental casing to prevent damage from weight, fall, water and elements of change in Climate and Temperature.
i. This electronic device is made to work with its own corresponding wristband which also carries a replica of the same electronic device that is placed under the cushion of the inside based of the baby car seat and works simultaneously.
ii. When a child is placed in the car seat, that child's weight then activate the device by sending a beeping sound to the corresponding device in the wristband which will then activate the sensor.
iii. When the child is removed from the car seat the corresponding sensor in the wristband is deactivated by vibrating and subsequently stop vibrating after a few seconds.
iv. Each electronic device will have a code which will correspond with the electronic chip that is placed in the wristband and will be sold as a pair. (must not be sold separately).
